(19) United States
(12) Patent Application Publication
(10) Pub. No.: US 2004/0044511 A1
(43) Pub. Date: Mar. 4, 2004

(54) Circuit simulation method

(75) Inventors: Shinsaku Sekido, Kyoto (JP); Katsuhiro Ootani, Nara (JP); Yasuyuki Sahara, Kyoto (JP); Kazuhisa Nakata, Osaka (JP)

Correspondence Address: Jack Q. Lever, Jr., McDERMOTT, WILL & EMERY, 600 Thirteenth Street, N.W., Washington, DC, 20005-3096, US

(73) Assignee: MATSUSHITA ELECTRIC INDUSTRIAL CO., LTD

(21) Appl. No.: 10/644,730

(22) Filed: Aug. 21, 2003

(30) Foreign Application Priority Data
Aug. 27, 2002 (JP) 2002-246458

(51) Int. Cl. G06F 17/50

(52) U.S. Cl. 703/14

(57) ABSTRACT

In an inventive circuit simulation method, simulation is performed utilizing a circuit simulator, based on a netlist prepared using mask layout data for a circuit, and parameters obtained from measurement data concerning the characteristic of each transistor. The parameters are extracted from the measurement data based on not only the transistor size but also a stress applied to the transistor. Therefore, the circuit simulation can be performed with precision and accuracy never before possible, in consideration of a change in the characteristic of the transistor which is caused by the stress applied thereto.

### BACKGROUND OF THE INVENTION

The present invention generally relates to circuit simulation methods to be employed in designing a semiconductor integrated circuit.

Recently, in the field of LSIs such as semiconductor integrated circuits including MIS transistors, design specifications required for the integrated circuits have been more diversified and more complicated with increases in fineness of patterning for semiconductor elements, the number of semiconductor elements integrated on a chip, and the operating speed of each semiconductor element.

In order to meet design specifications for various kinds of integrated circuits, each elementary circuit that has been designed or integrated circuit is subjected to circuit simulation so as to verify the function of each elementary circuit or the operation of the overall integrated circuit. In this case, parameters indicative of the characteristics of MIS transistors are extracted, and these parameters are used to predict how each MIS transistor operates.

Normally, the obtainment of measurement data indicative of the characteristics of MIS transistors, utilized in the above-mentioned parameter extraction, requires the use of a semiconductor wafer on which several kinds of MIS transistors different in size (gate length L and gate width W) are formed. To be more specific, the principal characteristics (e.g., electrical characteristics) of the MIS transistors formed on the wafer are measured, and parameters for the MIS transistors are extracted based on the electrical characteristics of the transistors.

Hereinafter, parameters that have been used in conventional circuit simulation will be described in detail with reference to the accompanying drawings.

FIG. 12 is a graph showing the measurement results of drain current when different drain voltages (or source/drain voltages) Vd and gate voltages Vg are applied to a certain MIS transistor. From the measurement results shown in the graph, it can be understood that a drain current (Id)-drain voltage (Vd) curve is drawn for each of the gate voltages Vg (Vg 1, Vg 2 and Vg 3).

In the conventional circuit simulation, the measurement values obtained with the drain current Id, drain voltage Vd and gate voltage Vg varied at appropriate steps are converted into Spice parameters, and these parameters are introduced into a circuit simulator. Furthermore, intermediate values between the measured points are interpolated using the Spice parameters, and are introduced into the simulator.

FIG. 13 is a graph showing the relationship between the gate length L and drain current Id in the transistor when the drain voltage Vd and gate voltage Vg are kept constant. In the graph, “OD=0.3 μm” and “OD=5.0 μm” each represent the width of a source/drain region (active region) extending, at one side, from one end of a gate electrode to an isolation region in a direction parallel to the gate length.

As can be seen from the characteristic curves obtained when “Id=Id 1” and “Id=Id 2” hold true, the characteristic of the transistor varies with a change in the gate length thereof Therefore, measurement has to be also carried out with the transistor size (i.e., gate length L and gate width W) varied, and parameters responsive to the respective transistor sizes need to be provided based on the measurement.

However, it is actually difficult to provide a parameter for each transistor; therefore, a parameter is provided for several transistor sizes and is used in circuit simulation.

FIG. 14 is a graph showing each range of transistor size to which a corresponding one of parameters divided into four is applicable. Specifically, illustrated in the graph is an example in which four parameters 1 to 4 are provided, and four transistor size ranges 1 to 4 to which the corresponding parameters are applicable are provided. For example, circuit simulation is performed using the parameter 1 when the transistor size is in the range 1 in which a gate width is between W1 and W2 and a gate length is between L2 and L3, and circuit simulation is performed using the parameter 4 when the transistor size is in the range 4 in which a gate width is between W2 and W3 and a gate length is between L1 and L2.

FIG. 15 is a block diagram showing a conventional circuit simulation system. As shown in FIG. 15, a circuit simulator normally receives a netlist extracted from mask layout data, and parameters extracted from measurement values indicative of device characteristics.

First, transistor size data 102, for example, is extracted from mask layout data 101 including design information concerning a circuit to be analyzed, and the transistor size data 102 is inputted as a netlist 103 to the circuit simulator 100. As a matter of fact, the netlist 103 includes not only information concerning the transistor size but also information concerning capacitance and resistance. It should be noted that although FIG. 15 shows the transistor data extracted from the mask layout data 101, data concerning elements such as capacitor and resistor used to form a circuit is also actually extracted from the mask layout data 101.

On the other hand, parameter extraction 105 necessary for circuit simulation is performed on measurement value data regarding a device for measurement (hereinafter, may also be called “device measurement data”) 104, and the extracted parameters are inputted as parameters 106 to the circuit simulator 100. In the step of the parameter extraction 105, the obtained measurement value data 104 is converted into the parameters 106. In the conventional method, not only the transistor size but also dopant concentration of a source/drain region and thickness of a gate insulating film, for example, have been considered.

Next, the inputted parameters 106 are checked against the netlist 103 in the circuit simulator 100. Then, in the circuit simulator 100, an optimum model parameter 106a is selected for each transistor size 103a from among the inputted parameters 106, and circuit operation is simulated.

For example, when a certain input signal is fed to the circuit to be analyzed, the simulation results indicating what kind of an output signal is obtained at an output terminal are provided as output results 107. In addition, circuit delay can be calculated in consideration of various resistances and capacitances. As the circuit simulator, a “SPICE” simulator or a tool obtained by making a modification to the simulator is generally used.

Normally, circuit layout is modified with reference to the results of the simulation performed by the circuit simulator, and then simulation is performed again on the modified layout by following the procedures similar to those described above. By repeating the procedures, an optimum circuit design can be carried out.

In the above-described circuit simulation, based on design data regarding the transistor size and the inputted measurement data, the measurement data indicative of the electrical characteristic closest to the design size of each transistor is assigned to the corresponding transistor. Accordingly, it is basically impossible to eliminate an error between the calculated value obtained by the circuit simulation and the measurement value obtained using the actual circuit. Therefore, what is called for is to reduce the error between the calculated value in the circuit simulation and the measurement value to a level that causes no problem in circuit design.

Suppose that the conventional method is performed using only a transistor size as a parameter when large design rules are used for an integrated circuit. Even in such a case, corrections are made in consideration of, for example, the shape of a gate electrode, the depth of a source/drain region and a dopant concentration thereof, thereby reducing an output error to a value that causes no problem from a practical standpoint.

As the miniaturization of integrated circuits advances, however, the use of the conventional circuit simulation method has been causing an error between an actual circuit operation and an expected circuit operation to become more and more pronounced. Such an error in regard to circuit operation is aggravated when a MIS transistor or a bipolar transistor is provided, in particular, among various types of electronic devices.

It is expected that the miniaturization of integrated circuits continues to advance, and the use of design rules on the order of 0.13 μm or less, in particular, strongly demands more precise and accurate circuit simulation.

### SUMMARY OF THE INVENTION

It is therefore an object of the present invention to provide more reliable and precise circuit simulation method applicable to integrated circuit design in which finer design rules are used.

An inventive circuit simulation method includes the steps of (a) recognizing, from mask layout data for an integrated circuit, the shape of an electronic device to be analyzed which is provided in the integrated circuit, and obtaining data concerning the size of the electronic device to be analyzed; (b) determining the electrical characteristic of an electronic device for measurement, and measuring the size of each portion of the electronic device for measurement, as well as items each serving as an index of a stress applied to the electronic device to be analyzed; (c) extracting, based on at least the size of each portion of the electronic device for measurement, parameters from data concerning the electrical characteristic of the electronic device for measurement which has been determined in the step (b); and (d) utilizing a circuit simulator to select, from among the extracted parameters, a parameter suitable for each electronic device to be analyzed which is provided in the integrated circuit, and to perform circuit simulation in consideration of a stress applied to each electronic device to be analyzed.

According to the inventive method, the influence of stresses that has not been considered in conventional methods is factored into the parameters for the electronic device to be analyzed, which have been provided for each size. Consequently, the circuit simulation can be performed accurately and precisely in consideration of a change in the characteristic of the electronic device (e.g., transistor) caused by a stress applied thereto.

In one embodiment of the inventive method, in the step (b), at least an item serving as an index of a stress applied from an isolation insulating film to the electronic device to be analyzed is preferably measured, and in the step (d), the circuit simulation is preferably performed in consideration of the stress applied from the isolation insulating film to the electronic device to be analyzed. In such an embodiment, all the stresses applied to the electronic device to be analyzed can each be approximated to the stress applied from the isolation insulating film. Accordingly, it becomes possible to relatively easily perform the accurate and precise circuit simulation in consideration of the stresses.

In another embodiment of the inventive method, in the step (c), a plurality of parameters are preferably extracted for each of the equal-sized electronic devices to be analyzed, based on the items each serving as an index of a stress applied to the electronic device to be analyzed. In such an embodiment, the parameter that is close to the actual characteristic can be applied to each electronic device to be analyzed. As a result, it becomes possible to perform the circuit simulation with high degrees of precision, accuracy and reliability as never before.

In still another embodiment of the inventive method, the method preferably further includes, prior to the step (d), the step of inputting an additional model to the circuit simulator, the additional model being prepared based on measurement data that has been obtained in the step (b) and that serves as an index of a stress. And in the step (d), a correction is preferably made using the additional model when selecting a parameter suitable for each electronic device to be analyzed which is provided in the integrated circuit. In such an embodiment, even if the parameters extracted in the step (c) is not extracted in consideration of stresses, it is possible to perform the circuit simulation with a high precision in consideration of stresses. Besides, if the parameter extraction with stresses factored in is performed in the step (c), it is possible to further improve the preciseness and accuracy of the circuit simulation by using the additional model.

In yet another embodiment of the inventive method, the method preferably further includes, prior to the step (d), the step of preparing a reference table including pieces of information for associating each electronic device to be analyzed, which is provided in the integrated circuit, with the parameter that should be assigned to the electronic device to be analyzed, and the step of inputting the reference table to the circuit simulator, the reference table being prepared based on the items each serving as an index of a stress applied to the electronic device to be analyzed. And in the step (d), the selection of the parameter suitable for each electronic device to be analyzed which is provided in the integrated circuit is preferably automatically carried out using the reference table. In such an embodiment, the time required for the simulation can be shortened. Therefore, such an embodiment is effective particularly when the number of the electronic devices to be analyzed is large.

In one embodiment of the inventive method, the reference table is preferably used to associate each electronic device to be analyzed, which is provided in the integrated circuit, with a plurality of weighted parameters. In such an embodiment, since new parameters can be prepared by combining a plurality of parameters, the circuit simulation can be performed with a higher degree of precision by using the new parameters.

In another embodiment of the inventive method, the electronic device to be analyzed and the electronic device for measurement are each preferably formed by a MIS transistor or a bipolar transistor. Among various types of electronic devices, a MIS transistor and a bipolar transistor are likely to vary in electrical characteristic due to stresses applied thereto. Therefore, if parameters provided in consideration of stresses are used for a MIS transistor or a bipolar transistor, it becomes possible to easily perform the circuit simulation with a higher degree of precision as compared with the case where parameters provided in consideration of stresses are used for all types of electronic devices.

In still another embodiment of the inventive method, the electronic device to be analyzed and the electronic device for measurement are each preferably formed by a MIS transistor including a gate electrode, a gate insulating film, an active region and an isolation insulating film surrounding the active region, and the items, each serving as an index of a stress applied to the electronic device to be analyzed, preferably include at least one of the position of the gate electrode in the active region, the size of the active region, and the width of the isolation insulating film. In such an embodiment, the influence of stresses can be factored in when the parameter extraction is performed, and furthermore, the influence of stresses can be factored in when the circuit simulation is performed.

In yet another embodiment of the inventive method, the items, each serving as an index of a stress applied to the electronic device to be analyzed, preferably further include at least one of the depth of the active region, a method for forming the isolation insulating film, the depth of the isolation insulating film, a material for use in forming the isolation insulating film, the size of the gate insulating film, and a material for use in forming the gate insulating film. In such an embodiment, the influence of stresses applied to the electronic device to be analyzed can be more closely reflected in the circuit simulation. As a result, the preciseness of the circuit simulation can be improved.

In one embodiment of the inventive method, in the step (d), the circuit simulation is preferably performed in consideration of a stress applied from the gate insulating film to the electronic device to be analyzed. In such an embodiment, the influence of stresses applied to the electronic device to be analyzed can be more closely reflected in the circuit simulation. As a result, the preciseness of the circuit simulation can be improved.

In another embodiment of the inventive method, in the step (b), at least an item that serves as an index of a stress applied from an interlayer dielectric film to the electronic device to be analyzed is preferably measured, and in the step (d), the circuit simulation is preferably performed in consideration of the stress applied from the interlayer dielectric film to the electronic device to be analyzed. In such an embodiment, again, the influence of stresses applied to the electronic device to be analyzed can be more closely reflected in the circuit simulation. As a result, the preciseness of the circuit simulation can be improved.

### BRIEF DESCRIPTION OF THE DRAWINGS

FIG. 1 is a block diagram illustrating a circuit simulation method according to a first embodiment of the present invention.

FIG. 2 is a block diagram illustrating a circuit simulation method according to a second embodiment of the present invention.

FIG. 3 is a block diagram illustrating a modified example of the circuit simulation method according to the second embodiment.

FIG. 4 is a block diagram illustrating a circuit simulation method according to a third embodiment of the present invention.

FIG. 5 is a block diagram illustrating a circuit simulation method according to a fourth embodiment of the present invention.

FIGS. 6A and 6B are plan views each showing an exemplary MIS transistor including an active region and a gate electrode positioned in the active region. The transistors are equal in size, whereas their gate electrodes are different in position.

FIGS. 7A through 7C are plan views each showing an exemplary MIS transistor including an active region and a gate electrode positioned in the active region. The active regions of the transistors are different in size, or the gate electrodes in the active regions are different in position.

FIGS. 8A through 8C are plan views each showing an exemplary MIS transistor. The transistors are surrounded by different-sized isolation insulating films.

FIGS. 9A through 9C are plan views each showing another exemplary MIS transistor. The transistors are surrounded by different-sized isolation insulating films.

FIG. 10 is a plan view of a MIS transistor, which is used to show exemplary main items that should be measured in order to obtain parameters in which the influence of stresses are factored in.

FIGS. 11A and 11B are tables each showing a summary of items each used as an index of stress applied to the MIS transistor shown in FIG. 10.

FIG. 12 is a graph showing the electrical characteristics of a MIS transistor having a certain size when different gate voltages Vg are applied.

FIG. 13 is a graph showing the relationship between gate length and drain current in the transistor when the drain voltage Vd and gate voltage Vg are kept constant.

FIG. 14 is a graph showing exemplary transistor size ranges to each of which a corresponding one of parameters for circuit simulation is applied.

FIG. 15 is a block diagram showing a conventional circuit simulation system.

### DESCRIPTION OF THE PREFERRED EMBODIMENTS

With an eye to improving the accuracy of circuit simulation, we conducted studies on factors that have not been considered in conventional circuit simulation, among factors that influence operations of electronic devices. After studying various kinds of factors, we found that the operation of a transistor is influenced by stresses applied from its surroundings.

Among stresses applied to a transistor, a stress applied from an isolation insulating film surrounding the transistor has the greatest influence on the transistor operation. The stress applied from the isolation insulating film formed by providing, for example, a shallow trench isolation (STI) region pressurizes or compresses an active region of the transistor.

The characteristic curves “Id=Id 1” and “Id=Id 2” shown in FIG. 13 are the characteristic curves of MIS transistors that receive different stresses. The active regions of the transistors are different in size. Specifically, the characteristic curve “Id 1” is associated with “OD=0.3 μm”, while the characteristic curve “Id 2” is associated with “OD=5.0 μm” (“OD” represents the width of a source/drain region extending, at one side, from one end of a gate electrode to an isolation region in a direction parallel to the gate length, and this width will be hereinafter called a “one-side OD width”).

Suppose that the gate length is 0.3 μm in FIG. 13. In that case, the drain current Id 1 associated with “OD=0.3 μm” is about 150 μA/μm, and the drain current Id 2 associated with “OD=5.0 μm” is about 125 μA/μm. Accordingly, the drain currents Id 1 and Id 2 differ from each other due to the different OD widths. From this fact, it can be seen that transistor characteristic is considerably influenced by a stress applied from an isolation insulating film. FIG. 13 merely shows an example, and the electrical characteristic of a transistor varies depending on the conductivity type thereof, for example. However, it is true that the electrical characteristic of a transistor is considerably influenced by a stress applied thereto.

A stress applied from an isolation insulating film varies depending on the size of a transistor active region and/or a distance between the isolation insulating film and a gate electrode, for example. In light of this, the present inventors hit upon the idea of adding, as data to be measured, an active region size and/or a distance between a gate electrode and an isolation insulating film, for example, in order to utilize, as a new parameter for circuit simulation, an index of a stress applied to a transistor.

Hereinafter, preferred embodiments of a circuit simulation method according to the present invention will be described with reference to the accompanying drawings.

(First Embodiment)

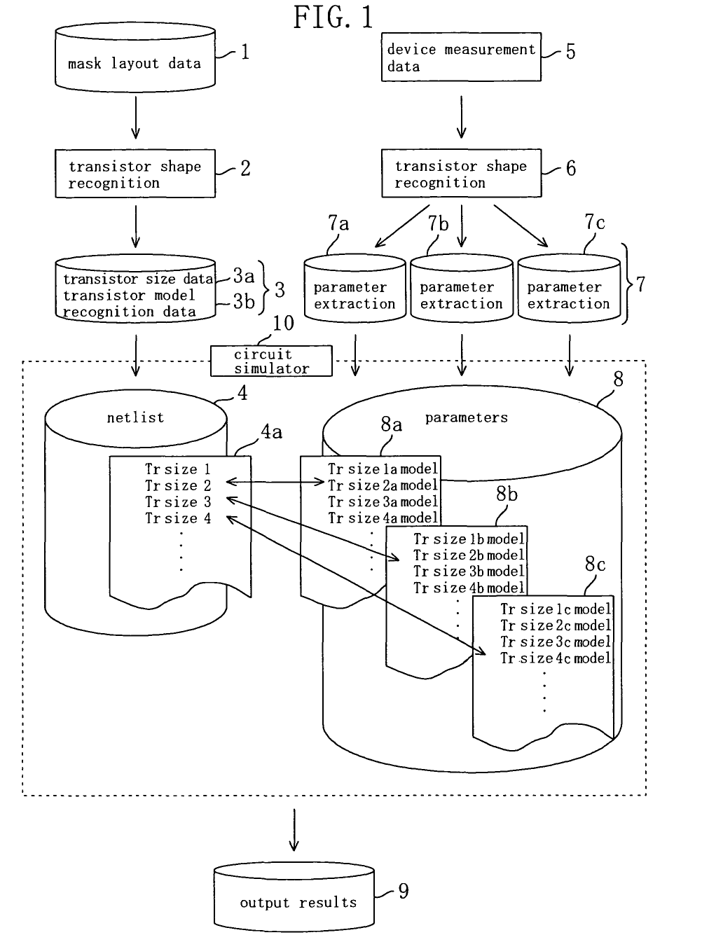

FIG. 1 is a block diagram illustrating a circuit simulation method according to a first embodiment of the present invention. According to the circuit simulation method of the present embodiment, a “SPICE” simulator or a modified one is utilized as in the conventional method, and an index of a stress applied to a transistor is used as a parameter in performing circuit simulation.

As shown in FIG. 1, in the circuit simulation method of the present embodiment, netlist and parameter data are inputted to a circuit simulator. The netlist and the data are prepared as follows.

First, how a netlist 4 is prepared will be described below.

The netlist 4 is extracted from mask layout data 1 regarding a circuit to be analyzed.

To be more specific, the step of recognizing the shape of each transistor is performed (hereinafter, called “transistor shape recognition” and identified by the reference numeral 2) based on the mask layout data 1. In the transistor shape recognition 2, each one-side OD width and each width of an isolation insulating film (hereinafter, may also be called an “isolation width”) are recognized.

Next, based on the results of the transistor shape recognition 2, the step of obtaining data including transistor size data 3a and transistor model recognition data 3b is performed. This step will be hereinafter called “data obtainment” and will be identified by the reference numeral 3. The transistor size data 3a obtained in this step includes pieces of information concerning transistor size (gate length and gate width), capacitance, resistance and wiring; for example. The transistor model recognition data 3b includes model names to be selected, which have been prepared manually based on each one-side OD width and each isolation width recognized in the transistor shape recognition 2. And the model names to be selected include data that serves as an index of stress.

Then, the transistor size data 3a and transistor model recognition data 3b are inputted, as the netlist 4, to a circuit simulator 10. It should be noted that although not shown, not only data concerning transistor but also data concerning resistance and capacitance, for example, are actually inputted to the circuit simulator 10.

Now, how the data for parameters 8 is prepared will be described.

The data for parameters 8 is extracted from measurement values, i.e., device measurement data 5, which have been obtained using a device for measurement. The device for measurement is one selected or formed for the measurement, and is of the same type as the analyzed device.

Suppose that MIS transistors are used for the measurement. In that case, the size of each transistor is determined by its gate length L and active region width W, and the electrical characteristics of the MIS transistors different in size are determined, thus obtaining the device measurement data 5. Furthermore, the thickness of a gate insulating film, the shape of a source/drain region, a dopant concentration thereof, and a dopant concentration of a substrate, for example, are also measured under various conditions. In addition, in the present embodiment, factors related to stresses are also measured under various conditions.

Subsequently, the step of recognizing the shape of each transistor (hereinafter, simply called “transistor shape recognition” and identified by the reference numeral 6) is performed based on the device measurement data 5. In the transistor shape recognition 6, measured one-side OD widths and isolation widths are recognized.

Then, parameter extraction 7 is performed based on the results of the transistor shape recognition 6. Shown in FIG. 1 is an example in which parameter extractions 7a, 7b and 7c are carried out for three transistors that receive different stresses, based on parameters indicative of the stresses. Although the exemplary case where three kinds of stresses are applied is shown in FIG. 1, the parameter extraction may be carried out for four or more kinds of stresses. The parameter extraction 7 includes the step of converting the obtained device measurement data 5 into parameters 8 including model parameter groups 8a, 8b and 8c provided in accordance with the magnitude of each stress.

Next, the circuit simulator 10 receives the parameters 8 including the converted model parameter groups 8a, 8b and 8c indicating the characteristics of the transistors each varied in accordance with the magnitude of stresses applied thereto.

Then, upon receipt of the netlist 4 and the parameters 8 for the transistors, the circuit simulator 10 is utilized to select, based on the data included in the netlist 4, an optimum model parameter for each transistor size 4a from among the model parameter groups 8a, 8b and 8c provided in consideration of stresses, and circuit simulation is performed. In this case, information used for determining which of the model parameters is selected for each transistor is inputted based on the transistor model recognition data 3b.

Subsequently, the parameters assigned to the respective transistors are used to obtain calculation results (i.e., output results) 9 from the circuit simulator 10.

If the conventional circuit simulation method is performed in the circuit simulator 10, a designer has no other choice but to assign identical parameters to equal-sized transistors that receive different stresses, since no parameters are provided in consideration of stresses in the conventional method. Therefore, an error is caused by characteristic variations resulting from different stresses, thus making it difficult to perform accurate circuit simulation.

To the contrary, the circuit simulation method of the present embodiment makes it possible to select an optimum model parameter for each of equal-sized transistors, for example, from among the model parameter groups 8a, 8b and 8c in accordance with the stresses applied to the transistors. In the example shown in FIG. 1, an optimum model parameter can be selected for a transistor with a size of “Tr size 1” from among “Tr size 1a model”, “Tr size 1b model” and “Tr size 1c model” in accordance with the applied stress.

Therefore, according to the circuit simulation method of the present embodiment, the preciseness and accuracy of the simulation are significantly improved as compared with the conventional method, and the simulation results can be utilized for circuit design in which finer design rules are used. Besides, according to the present embodiment, the number of stress-related factors to be measured, and the number of the parameter extractions are increased, thus making it possible to further improve the preciseness of the simulation. As described above, the circuit simulation method of the present embodiment is sufficiently adaptable to integrated circuit design in which finer design rules are used. Accordingly, the circuit simulation method of the present embodiment is preferably applied to circuit design in which design rules on the order of 0.13 μm or less are used, for example. Naturally, the circuit simulation method of the present embodiment may be effectively used in designing already-existing integrated circuits. Consequently, with the use of the inventive circuit simulation method, innovative integrated circuits can be developed in a short period of time, and thus the products that meet the needs of the market can be provided without delay.

The present inventors found items that should be measured in order to provide parameters in consideration of stresses, and these items are described below.

Stresses applied to a MIS transistor include a stress applied from an isolation insulating film, a stress applied from a gate insulating film, and a stress applied from an interlayer dielectric film, for example. Among them, the largest one is the stress applied from an isolation insulating film. Therefore, at least the following items are each used as an index for predicting the magnitude of the stress.

the size of an active region (length by width)

the length of the active region sandwiched between a gate electrode and an isolation insulating film (i.e., the position of the gate electrode in the active region)

the width of the isolation insulating film surrounding a transistor

Hereinafter, the exemplary items to be measured will be specifically described with reference to the drawings.

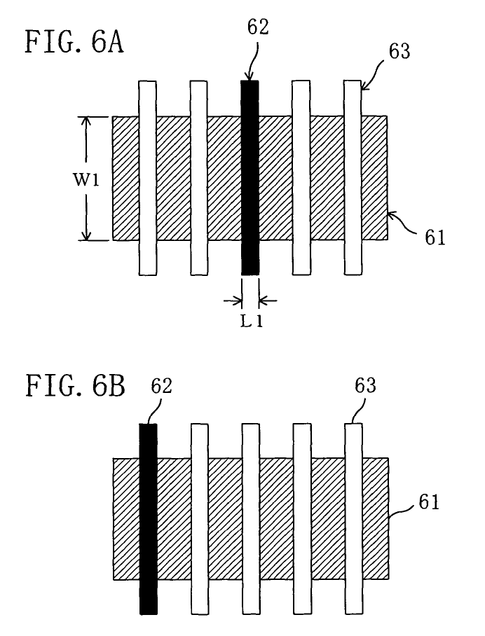

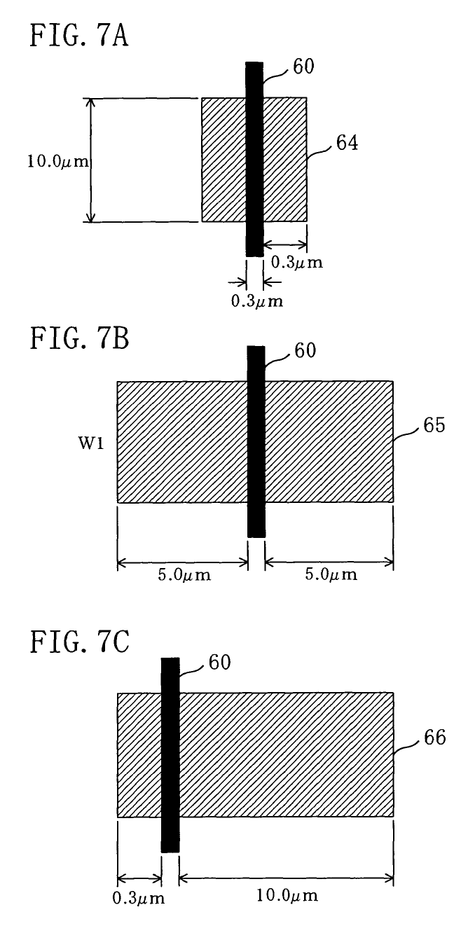

FIGS. 6A and 6B are plan views each showing an exemplary MIS transistor including an active region and a gate electrode positioned in the active region. The transistors shown in FIGS. 6A and 6B are equal in size, whereas their gate electrodes are different in position. Although not shown, each active region 61 is surrounded by an isolation insulating film (the same goes for FIG. 7).

As shown in each of the plan views, a gate electrode 62 and dummy gate electrodes 63 may be provided on one and the same active region 61 for manufacturing reasons, for example. In such a case, even if the transistors are equal in size, their electrical characteristics are different. It should be noted that the size of each transistor is determined by its gate length L1 and active region width W1.

The electrical characteristic of each exemplary transistor varies depending on the position of the gate electrode 62 because a distance between the gate electrode 62 and the isolation insulating film is varied depending on the position of the gate electrode 62. In the transistor shown in FIG. 6A, the gate electrode 62 is located in an approximate center of the active region 61; on the other hand, in the transistor shown in FIG. 6B, the gate electrode 62 is located at one side of the active region 61 and adjacent to the isolation insulating film. Therefore, the gate electrode 62 of the transistor shown in FIG. 6B is more susceptible to a stress applied from the isolation insulating film than the gate electrode 62 of the transistor shown in FIG. 6A, resulting in the transistors exhibiting different electrical characteristics.

FIGS. 7A through 7C are plan views each showing an exemplary MIS transistor including an active region and a gate electrode positioned in the active region. The active regions of the transistors are different in size, or the gate electrodes of the transistors are different in position. Shown in FIGS. 7A through 7C are exemplary MIS transistors each having a gate length L1 of 0.3μm and an active region width W1 of 10 μm. Herein, “active region width” means the width of an active region extending in a direction parallel to the gate width. Furthermore, “active region length (one-side OD width)” herein means the width of an active region extending, at one side, from one end of a gate electrode to an isolation insulating film in a direction parallel to the gate length.

FIG. 7A shows the exemplary MIS transistor in which a gate electrode 60 is located in the center of an active region 64, and parts of the active region 64 located on both sides of the gate electrode 60 each have a length of 0.3 μm.

FIG. 7B shows the exemplary MIS transistor in which a gate electrode 60 is located in the center of an active region 65, and parts of the active region 65 located on both sides of the gate electrode 60 each have a length of 5.0 μm.

And FIG. 7C shows the exemplary MIS transistor in which a gate electrode 60 is located at a left-side portion of an active region 66, and a part of the active region 66 located on the left of the gate electrode 60 has a length of 0.3 μm while another part of the active region 66 located on the right of the gate electrode 60 has a length of 10.0 μm.

Since the MIS transistors shown in FIGS. 7A and 7B are different in active region length, they receive different stresses from the isolation insulating films, and thus these MIS transistors exhibit different electrical characteristics. From this fact, it can be seen that the size of the active region can be used as an index of stress.

Further, the entire width of the active region in the MIS transistor shown in FIG. 7B, extending in a direction parallel to the gate length, is almost equal to that of the active region in the MIS transistor shown in FIG. 7C, extending in a direction parallel to the gate length; however, the gate electrodes of the MIS transistors shown in FIGS. 7B and 7C are different in position. Therefore, the gate electrodes of these transistors receive different stresses applied from the isolation insulating films, resulting in the transistors exhibiting different electrical characteristics.

In view of the above, it is clear that the length of a part of an active region located on right of a gate electrode, and the length of a part of an active region located on left of a gate electrode can each be used as an index of stress.

For example, in order to take into account the magnitude of each stress applied to the exemplary transistors shown in FIGS. 7A through 7C, the parameter extractions 7a, 7b and 7c are performed in accordance with the magnitude of each stress as shown in FIG. 1 in the present embodiment. Then, the parameters 8 including the results of the extractions, i.e., the model parameter groups 8a, 8b and 8c, are inputted to the circuit simulator 10, thereby making it possible to carry out the circuit simulation in consideration of the stresses.

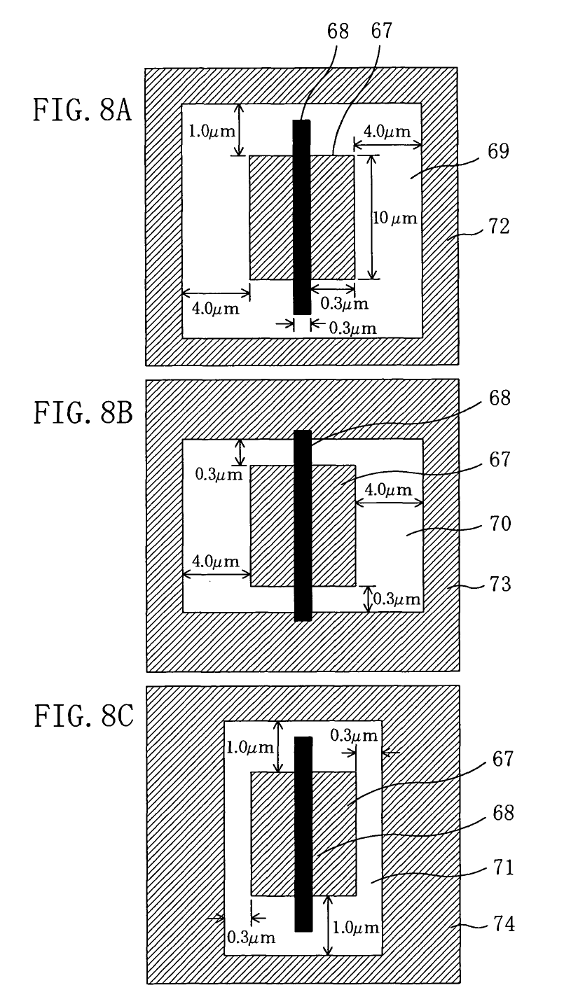

FIGS. 8A through 8C are plan views each showing an exemplary MIS transistor including an active region 67 and a gate electrode 68. The transistors are surrounded by different-sized isolation insulating films. It should be noted that not only the active regions 67 but also the gate electrodes 68 are similar in size and shape. To be more specific, the gate length of each gate electrode 68 is 0.3 μm, the width of each active region 67 extending in a direction parallel to the gate width is 10 μm, and the width of each active region 67 extending in a direction parallel to the gate length is 0.9 μm (0.3 μm+0.3 μm+0.3 μm). It should also be noted that the active regions 67 are equal in length and the gate electrodes 68 on the active regions 67 are similar in position.

In the MIS transistor shown in FIG. 8A, an isolation insulating film 69 is formed to surround the periphery of the active region 67, and a semiconductor region (outward active region) 72 is formed to surround the periphery of the isolation insulating film 69. As shown in FIG. 8A, right and left portions of the isolation insulating film 69 located on the right and left of the active region 67, respectively, each have an isolation width of 4.0 μm in a direction parallel to the gate length, while upper and lower portions of the isolation insulating film 69 located over and under the active region 67, respectively, each have an isolation width of 1.0 μm in a direction parallel to the gate width.

In the MIS transistor shown in FIG. 8B, an isolation insulating film 70 is formed to surround the periphery of the active region 67, and a semiconductor region (outward active region) 73 is formed to surround the periphery of the isolation insulating film 70. As shown in FIG. 8B, right and left portions of the isolation insulating film 70 located on the right and left of the active region 67, respectively, each have an isolation width of 4.0 μm in a direction parallel to the gate length, while upper and lower portions of the isolation insulating film 70 located over and under the active region 67, respectively, each have an isolation width of 0.3 μm in a direction parallel to the gate width.

In the MIS transistor shown in FIG. 8C, an isolation insulating film 71 is formed to surround the periphery of the active region 67, and a semiconductor region (outward active region) 74 is formed to surround the periphery of the isolation insulating film 71. As shown in FIG. 8C, right and left portions of the isolation insulating film 71 located on the right and left of the active region 67, respectively, each have an isolation width of 0.3 μm in a direction parallel to the gate length, while upper and lower portions of the isolation insulating film 71 located over and under the active region 67, respectively, each have an isolation width of 1.0 μm in a direction parallel to the gate width.

The right and left portions of the isolation insulating film 69 shown in FIG. 8A and those of the isolation insulating film 70 shown in FIG. 8B have identical isolation widths (i.e., 4.0 μm) in a direction parallel to the gate length. However, the upper and lower portions of the isolation insulating film 69 shown in FIG. 8A and those of the isolation insulating film 70 shown in FIG. 8B have different isolation widths (i.e., 1.0 μm in FIG. 8A, and 0.3 μm in FIG. 8B) in a direction parallel to the gate width. In this case, the transistors shown in FIGS. 8A and 8B exhibit different electrical characteristics. This is because the magnitude of a stress applied to a transistor varies in accordance with the isolation width of an isolation insulating film surrounding the transistor.

Furthermore, the upper and lower portions of the isolation insulating film 69 shown in FIG. 8A and those of the isolation insulating film 71 shown in FIG. 8C have identical isolation widths (i.e., 1.0 μm) in a direction parallel to the gate width. However, the right and left portions of the isolation insulating film 69 shown in FIG. 8A and those of the isolation insulating film 71 shown in FIG. 8C have different isolation widths (i.e., 4.0 μm in FIG. 8A, and 0.3 μm in FIG. 8C) in a direction parallel to the gate length. In this case again, the transistors shown in FIGS. 8A and 8C exhibit different electrical characteristics.

In view of the above, it is apparent that the size (isolation width) of an isolation insulating film surrounding a MIS transistor can be used as an index of a stress.

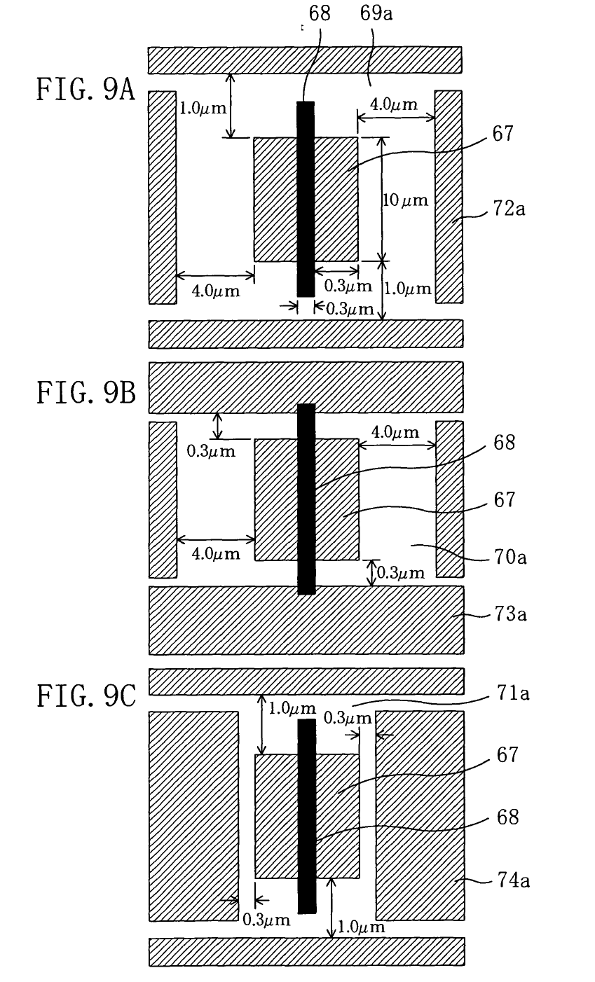

FIGS. 9A through 9C are plan views each showing another exemplary MIS transistor including an active region 67 and a gate electrode 68. The exemplary MIS transistors shown in FIGS. 9A, 9B and 9C are surrounded by different-sized isolation insulating films 69a, 70a and 71a, respectively The active region 67 and gate electrode 68 of each MIS transistor shown in FIGS. 9A through 9C are similar to those of each MIS transistor shown in FIGS. 8A through 8C. And the isolation insulating films 69a, 70a and 71a shown in FIGS. 9A through 9C, and the isolation insulating films 69, 70 and 71 shown in FIGS. 8A through 8C have similar isolation widths not only in a direction parallel to the gate length but also in a direction parallel to the gate width. However, the MIS transistors shown in FIGS. 9A through 9C are different from those shown in FIGS. 8A through 8C in that semiconductor regions 72a, 73a and 74a located outwardly of the isolation insulating films 69a, 70a and 71a, respectively, are each divided into four sections. In this case again, the magnitude of stresses applied to the MIS transistors shown in FIGS. 9A through 9C are different from each other.

In light of the above, the items, each used as an index of a stress indicative parameter, are summarized as follows.

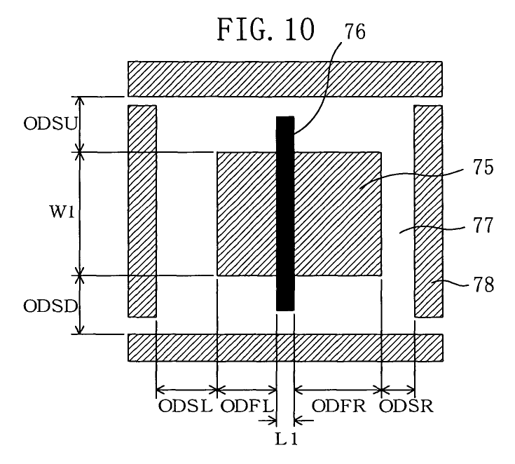

FIG. 10 is a plan view of a MIS transistor, which is used to show exemplary main items that should be measured in order to obtain parameters in which the influence of stress is factored. Illustrated in FIG. 10 are an active region (inward active region) 75, a gate electrode 76, an isolation insulating film 77 and a semiconductor region (outward active region) 78.

As shown in FIG. 10, the main items each used as an index of stress in the circuit simulation of the present embodiment include, in addition to transistor size (gate length L1, and gate width W1), the one-side OD widths of the inward active region 75, and the isolation widths of the isolation insulating film 77 surrounding the active region 75. To be more specific, the main items include: the one-side OD width (ODFL) of a left portion of the inward active region 75 located on the left of the gate electrode 76; the one-side OD width (ODFR) of a right portion of the inward active region 75 located on the right of the gate electrode 76; the isolation width (ODSL) of a left portion of the isolation insulating film 77 located on the left of the active region 75 in a direction parallel to the gate length; the isolation width (ODSR) of a right portion of the isolation insulating film 77 located on the right of the active region 75 in a direction parallel to the gate length; the isolation width (ODSU) of an upper portion of the isolation insulating film 77 located over the active region 75 in a direction parallel to the gate width; and the isolation width (ODSD) of a lower portion of the isolation insulating film 77 located under the active region 75 in a direction parallel to the gate width. Herein, the widths ODFL and ODFR are collectively called “OD finger”, while the widths ODSL, ODSR, ODSU and ODSD are collectively called “OD separate”.

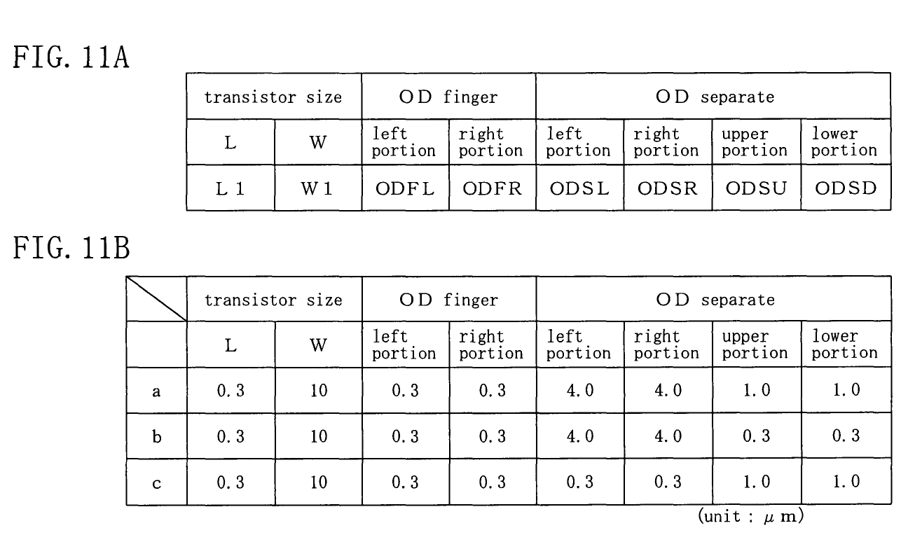

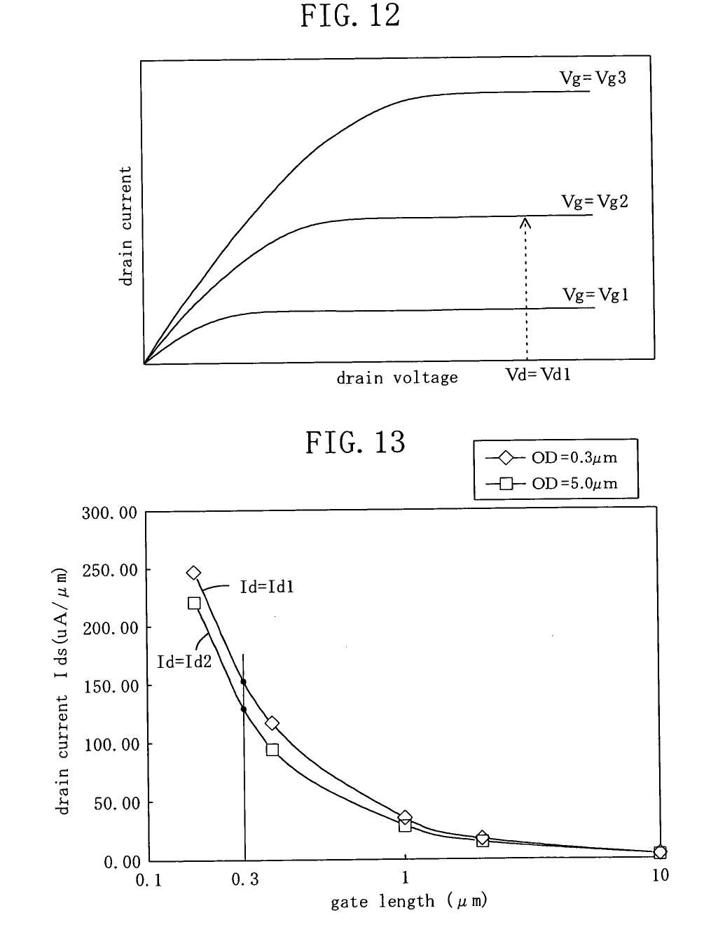

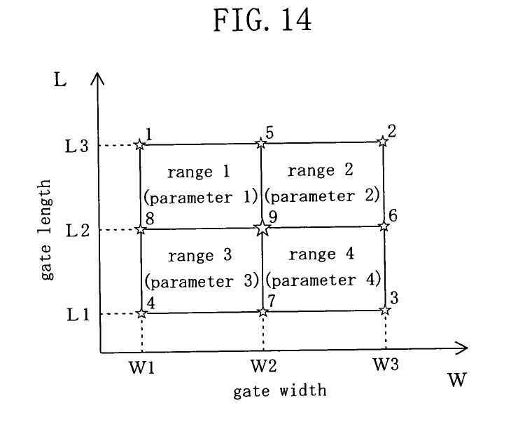

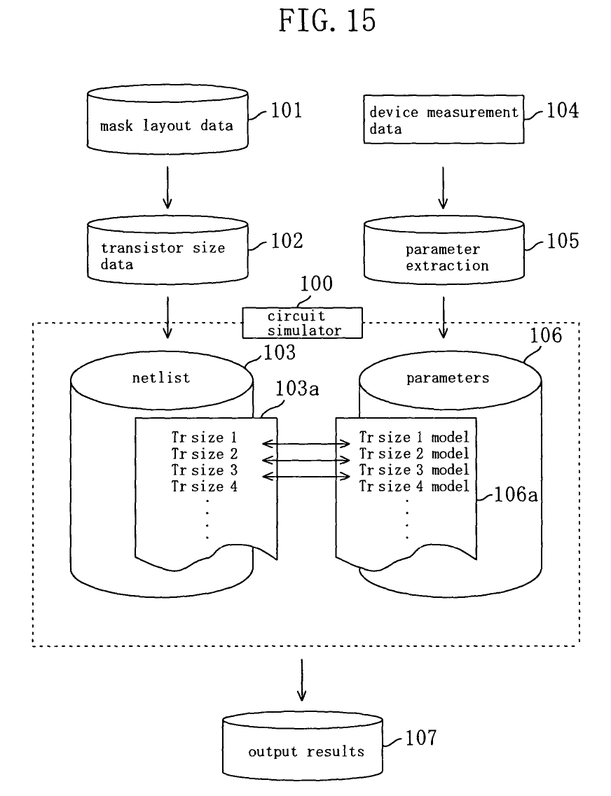

FIGS. 11A and 11B are tables each showing a summary of items each used as an index of stress applied to the MIS transistor shown in FIG. 10. To be more specific, FIG. 11B shows each index of stress applied to the MIS transistors shown in FIGS. 9A through 9C.

Each of the items shown above is measured as an index, and parameter extraction is performed based on the measurement, thus performing the high-precision circuit simulation using the extracted parameters in which the stresses applied to the MIS transistors are factored in.

If the active region or isolation insulating film has a complicated shape, the other item having an influence on stress may be optionally added as the index. In such a case, the simulation can be performed with a higher degree of precision.

Strictly speaking, a stress to be applied varies depending on the depths of isolation insulating film and active region, and a method for forming the isolation insulating film. Therefore, the circuit simulation can be performed with a higher degree of precision by taking into account the data concerning the depths of isolation insulating film and active region, and the method for forming the isolation insulating film.

Besides, a stress to be applied to a transistor varies depending on the material properties of an isolation insulating film. For example, there is a difference between a stress to be applied to a transistor in the case where SiO₂ containing no dopant is used, and a stress to be applied to a transistor in the case where BPSG (which is SiO₂ containing boron and phosphorus) is used.

In addition, the size, thickness, material properties of a gate insulating film can be used as an additional index from the view point of stress. If an SOI substrate is used, the position of a buried oxide film, for example, can be used as an index of stress. Furthermore, by adding the thickness of an interlayer dielectric film as an index of stress, the simulation can be performed in consideration of the stress applied from the interlayer dielectric film.

Although the circuit simulation method of the present embodiment has been described on the supposition that stress indicative parameters are assigned to MIS transistors, the parameters may also be assigned to bipolar transistors. In such a case, the items each used as an index of stress include: a distance between each of regions (which serve as a base, an emitter and a collector) and an isolation insulating film; and the size of the isolation insulating film. In addition, the present embodiment is also applicable to transistors other than those described above, capacitors, resistors, and diodes. The same goes for the embodiments described below.

(Second Embodiment)

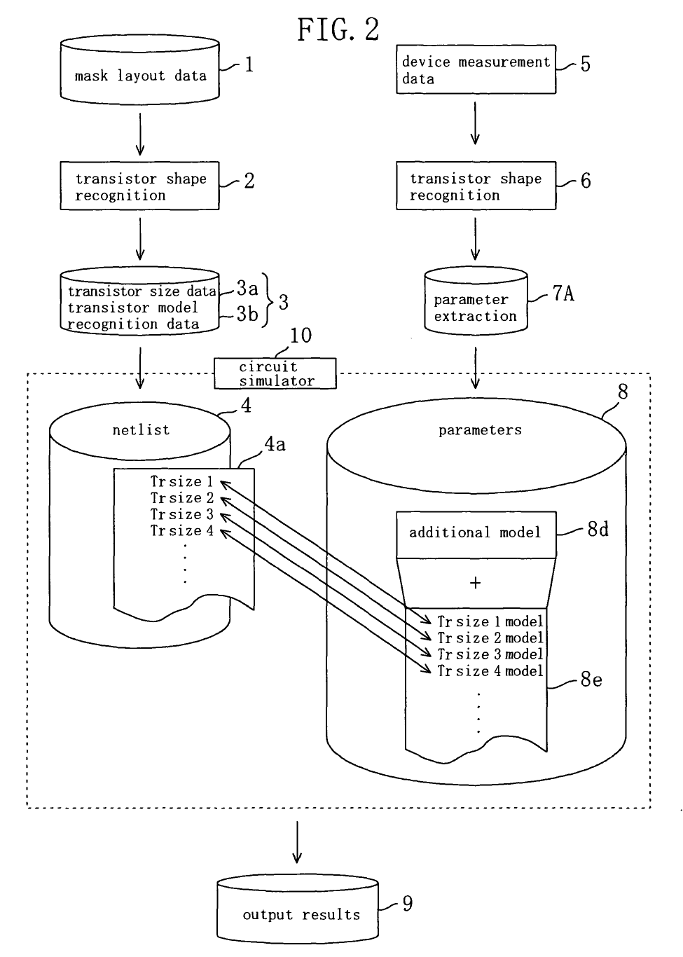

FIG. 2 is a block diagram illustrating a circuit simulation method according to a second embodiment of the present invention. According to the circuit simulation method of the present embodiment, an additional model is extracted from measurement data that serves as an index of the influence of stress, and is inputted to a circuit simulator. It should be noted that the same reference numerals as those used in FIG. 1 (first embodiment) are used in FIG. 2 where appropriate.

As shown in FIG. 2, in the circuit simulation method of the present embodiment, not only a netlist 4 and parameters 8 but also an additional model 8d are inputted to a circuit simulator 10. The additional model 8d serves to correct the parameter assigned to each transistor in accordance with the magnitude of stress applied thereto.

Parameter extraction 7A is performed on measurement values, i.e., device measurement data 5, each serving as an index of stress applied to a transistor (e.g., the OD finger, OD separate, and the depth of an isolation insulating film which have been described in the first embodiment), and the measurement values are converted into parameters and are inputted, as the additional model 8d, to the circuit simulator 10.

Like the first embodiment, a netlist 4 is extracted from mask layout data 1 regarding a circuit to be analyzed. That is, the step of recognizing the shape of each transistor, i.e., transistor shape recognition 2, is performed based on the mask layout data 1, and then the step of obtaining data including transistor size data 3a and transistor model recognition data 3b, i.e., data obtainment 3, is performed based on the results of the transistor shape recognition 2. The transistor size data 3a to be obtained in this step includes pieces of information concerning transistor size (gate length, and gate width), a dopant concentration of a source/drain region, capacitance, resistance and wiring, for example. The transistor model recognition data 3b includes model names to be selected, which have been prepared manually based on each one-side OD width and each isolation width recognized in the transistor shape recognition 2. And the model names to be selected include data that serves as an index of stress.

In the method of the present embodiment, the step of recognizing the shape of each transistor, i.e., transistor shape recognition 6, is performed based on the size of each transistor as in the conventional method, and the parameter extraction 7A is performed based on the measurement values, i.e., the device measurement data 5. Therefore, basically, one parameter is assigned to equal-sized transistors.

However, in the circuit simulation method of the present embodiment, a correction is made using the additional model 8d in accordance with the magnitude of stress applied to each transistor when selecting a model parameter 8e for each transistor size 4a, thus making it possible to perform the simulation more precisely and accurately than the conventional simulation. In this embodiment, the selection of the parameter suitable for each transistor is carried out manually based on the prepared transistor model recognition data 3b. Alternatively, the selection may be carried out automatically utilizing computer software as in the embodiment described below.

According to the method of the present embodiment, the additional model 8d that serves to correct parameters in accordance with the magnitude of stresses is added to the conventional model parameters 8e. Therefore, even if model parameters in which stresses are factored in are not available in a circuit simulator, the circuit simulation can be carried out with great precision in consideration of stresses by utilizing the additional model 8d, and thus high-precision output results 9 can be obtained. Furthermore, the preciseness of the simulation may be improved by preparing an additional model that indicates the magnitude of stress in greater detail.

In addition, the additional model can be also used when the parameter extraction is performed in consideration of the magnitude of stress as in the first embodiment.

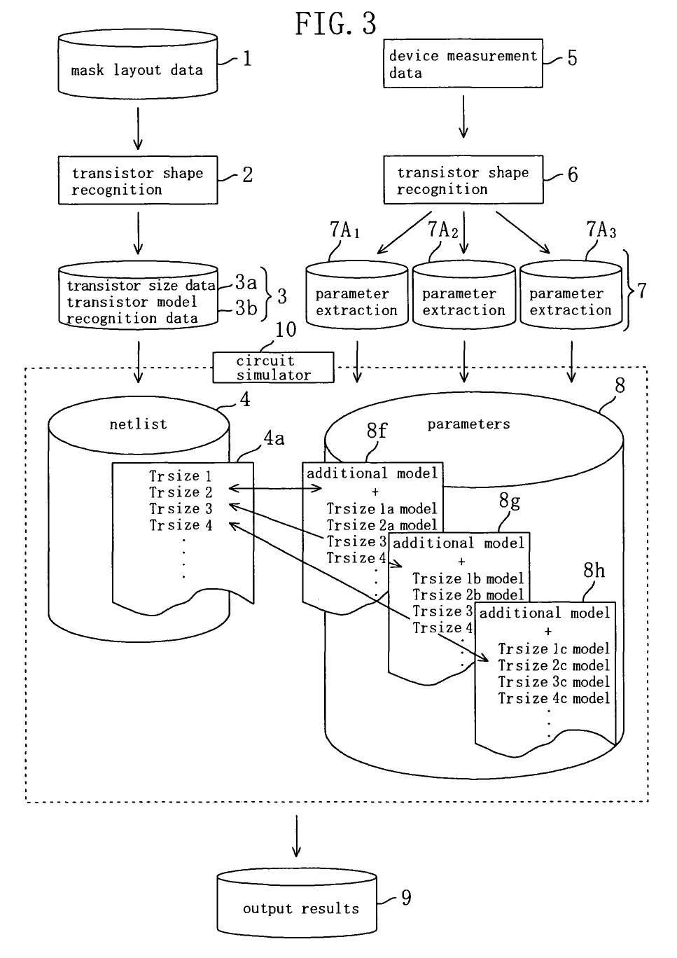

FIG. 3 is a block diagram illustrating a modified example of the circuit simulation method of the second embodiment. The modified example shown in FIG. 3 is different from the second embodiment shown in FIG. 2 in that parameter extractions 7A₁, 7A₂ and 7A₃ are performed for equal-sized transistors in accordance with three magnitudes of stresses, for example. Furthermore, in a circuit simulator 10, model parameter groups 8f, 8g and 8h are prepared for equal-sized transistors. Into the model parameter groups 8f, 8g and 8h, three additional models a, b and c are incorporated in accordance with respective applied stresses. Therefore, an optimum model parameter can be selected from among the model parameter groups 8f, 8g and 8h for each of equal-sized transistors in accordance with applied stress.

For example, although stress is factored into “Tr size 1a model” in the first embodiment shown in FIG. 1, stress is not factored into “Tr size 1a model” in the modified example of the second embodiment shown in FIG. 3. However, in the modified example of the second embodiment, the simulation can be performed in consideration of stress by making a correction using “additional model a”.

That is, in this modified example, the circuit simulation can be performed with a higher degree of precision since a correction is made to the three model parameter groups 8f, 8g and 8h in consideration of stress by using the additional models a, b and c. However, for the additional models a, b and c, data that is more detailed than data used for the parameter extractions 7A₁, 7A₂ and 7A₃ has to be prepared.

As described above, in the circuit simulation method according to the present embodiment or the modified example thereof, a correction is made in consideration of the influence of stress by using the additional model(s), thus making it possible to further improve the preciseness of the simulation. Consequently, the circuit simulation method according to the present embodiment or the modified example thereof can be sufficiently applied to circuit design in which finer design rules are used.

(Third Embodiment)

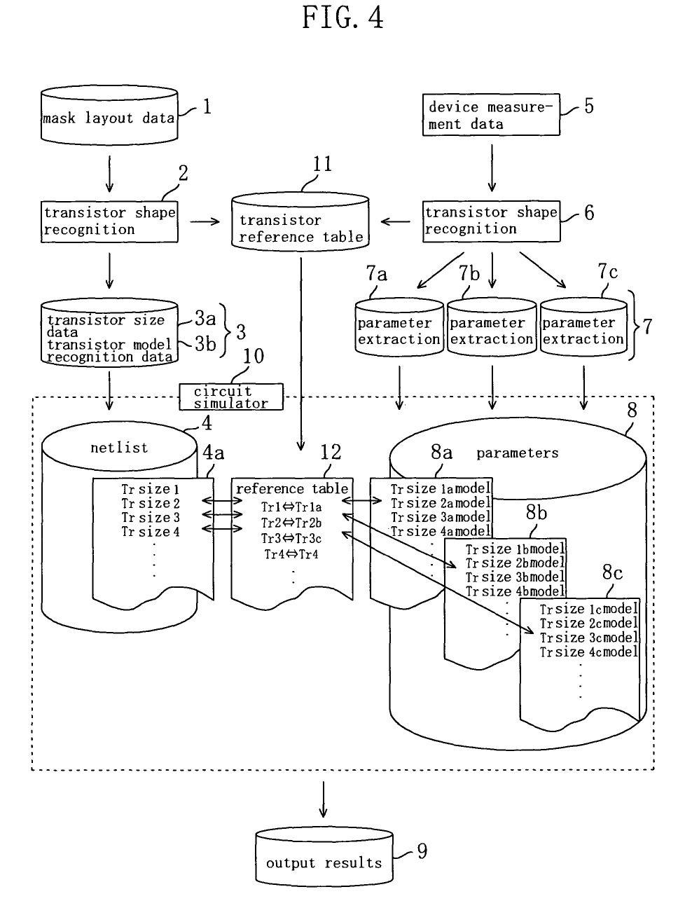

FIG. 4 is a block diagram illustrating a circuit simulation method according to a third embodiment of the present invention. It should be noted that the same reference numerals as those used in FIG. 1 (first embodiment) are used in FIG. 4 where appropriate.

The circuit simulation method of the third embodiment is different from that of the first embodiment in that the method of the third embodiment utilizes a reference table 12 for associating each transistor size 4a with an optimum model parameter selected from among model parameter groups 8a, 8b and 8c.

In the first embodiment, for the selection of a model parameter most suitable for each transistor size 4a included in the netlist 4, information used for associating each transistor size with each model parameter is manually inputted to the transistor model recognition data 3b by a designer. To the contrary, in the circuit simulation method of the third embodiment, the netlist 4, data for parameters 8, and reference table 12 are inputted to a circuit simulator 10. In this case, in the transistor model recognition data 3b, only oneside OD widths and isolation widths are inputted, and no model names are inputted unlike the first embodiment. In the circuit simulator 10, a model parameter suitable for each transistor size 4a is automatically selected from among the model parameter groups 8a, 8b and 8c based on information provided in the reference table 12.

After transistor shape recognition 2 performed using mask layout data 1, and transistor shape recognition 6 performed using device measurement data 5 have been completed, a transistor reference table 11 is manually prepared based on the results of both of the transistor shape recognition 2 and the transistor shape recognition 6. And the prepared transistor reference table 11 is automatically inputted, as the reference table 12, to the circuit simulator 10. In the reference table 12, for example, “Tr 1” is associated with a parameter “Tr 1a”, and “Tr 2” is associated with a parameter “Tr 2b”.

According to the present embodiment, in the circuit simulator 10, the reference table 12 is utilized to automatically select a model parameter that is most suitable for each transistor size. Therefore, even if the number of transistors is increased, it does not take much time to analyze the transistors. This is because, although the time required for the preparation of the reference table 12 does not change much with an increase in the number of transistors, the time required for the analysis performed by the circuit simulator is shorter as compared with the case where the analysis is performed manually.

Consequently, according to the circuit simulation method of the present embodiment, if the number of transistors is large, the time required for the analysis can be shorter as compared with the first embodiment. The preciseness of the simulation in the present embodiment is similar to that of the simulation in the first embodiment.

The present embodiment has been described as an example in which the reference table is utilized in the method of the first embodiment. Alternatively, the reference table may be effectively utilized when the additional model is used as described in the second embodiment.

(Fourth Embodiment)

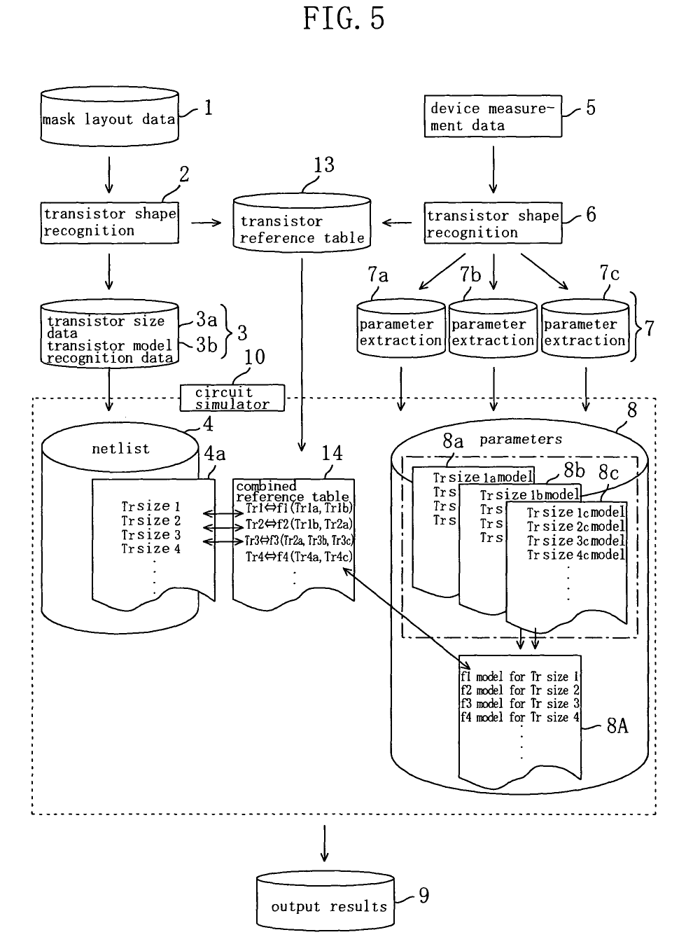

FIG. 5 is a block diagram illustrating a circuit simulation method according to a fourth embodiment of the present invention. It should be noted that the same reference numerals as those used in FIG. 4 (third embodiment) are used in FIG. 5 where appropriate. The fourth embodiment is different from the third embodiment in that a transistor reference table 13, a combined reference table 14, and a combined model parameter group 8A are added in the fourth embodiment.

As shown in FIG. 5, according to the circuit simulation method of the present embodiment, a plurality of parameters can be selected for one transistor by utilizing the combined reference table 14 in a circuit simulator 10.

The circuit simulator 10 receives a netlist 4, model parameter groups 8a, 8b and 8c, and the combined reference table 14 that has been prepared in advance based on the transistor reference table 13. In the present embodiment, the combined reference table 14 is utilized to select a plurality of model parameters for one transistor, and the circuit simulation is performed using the combined model parameter group 8A determined by the weighting of each model parameter. In this manner, output results 9 are obtained.

In the example shown in FIG. 5, model parameters “Tr 1a” and “Tr 1b” are selected for a transistor “Tr 1” by utilizing the combined reference table 14, and each of the parameters is weighted. For example, if a stress applied to the transistor “Tr 1” is at an intermediate value exactly between the value of the parameter “Tr 1a” and the value of the parameter “Tr 1b”, fl model “fl (Tr 1a, Tr 1b)=(Tr 1a×0.5+Tr 1b ×0.5)” is assigned to the transistor “Tr 1”. Thus, if a stress applied to a transistor is at an intermediate value between the values of the model parameters included in the model parameter groups 8a, 8b and 8c obtained by the parameter extractions 7a, 7b and 7c, a combined model parameter indicative of the intermediate value can be prepared and assigned to the transistor. In the third embodiment, however, an optimum model parameter indicative of the value of a stress is selected only from among the model parameter groups 8a, 8b and 8c which have been obtained by the parameter extractions 7a, 7b and 7c. To the contrary, according to the fourth embodiment, the circuit simulation can be performed using a combined model parameter indicative of an intermediate value between the values of model parameters, thus making it possible to obtain high-precision output results.

As described above, according to the circuit simulation method of the present embodiment, a plurality of parameters are selected for one transistor utilizing the combined reference table 14, and a combine model parameter is newly generated based on these parameters. As a result, it becomes possible to further improve the preciseness and accuracy of the circuit simulation. Which of the parameters is selected for a certain transistor and how the extracted model parameters are weighted may be determined by taking into consideration each index of stress such as the shape of an active region and the position of a gate electrode.

In the circuit simulation method of the present embodiment, two parameters do not necessarily have to be selected for one transistor, but three or more parameters may be selected for one transistor.

Furthermore, the circuit simulation method of the present embodiment may be effectively used when the additional model is utilized as in the second embodiment.

The present application claims the priority of Japanese Patent Application Number 2002-246458, the disclosure of which is incorporated herein by reference.

What is claimed is:

1. A circuit simulation method comprising the steps of
(a) recognizing, from mask layout data for an integrated circuit, the shape of an electronic device to be analyzed which is provided in the integrated circuit, and obtaining data concerning the size of the electronic device to be analyzed;
(b) determining the electrical characteristic of an electronic device for measurement, and measuring the size of each portion of the electronic device for measurement, as well as items each serving as an index of a stress applied to the electronic device to be analyzed;
(c) extracting, based on at least the size of each portion of the electronic device for measurement, parameters from data concerning the electrical characteristic of the electronic device for measurement which has been determined in the step (b); and
(d) utilizing a circuit simulator to select, from among the extracted parameters, a parameter suitable for each electronic device to be analyzed which is provided in the integrated circuit, and to perform circuit simulation in consideration of a stress applied to each electronic device to be analyzed.

2. The circuit simulation method of claim 1, wherein in the step (b), at least an item serving as an index of a stress applied from an isolation insulating film to the electronic device to be analyzed is measured, and
wherein in the step (d), the circuit simulation is performed in consideration of the stress applied from the isolation insulating film to the electronic device to be analyzed.

3. The circuit simulation method of claim 1, wherein in the step (c), a plurality of parameters are extracted for each of the equal-sized electronic devices to be analyzed, based on the items each serving as an index of a stress applied to the electronic device to be analyzed.

4. The circuit simulation method of claim 1, wherein the method further comprises, prior to the step (d), the step of inputting an additional model to the circuit simulator, the additional model being prepared based on measurement data that has been obtained in the step (b) and that serves as an index of a stress, and
wherein in the step (d), a correction is made using the additional model when selecting a parameter suitable for each electronic device to be analyzed which is provided in the integrated circuit.

5. The circuit simulation method of claim 1, wherein the method further comprises, prior to the step (d), the step of preparing a reference table including pieces of information for associating each electronic device to be analyzed, which is provided in the integrated circuit, with the parameter that should be assigned to the electronic device to be analyzed, and the step of inputting the reference table to the circuit simulator, the reference table being prepared based on the items each serving as an index of a stress applied to the electronic device to be analyzed, and
wherein in the step (d), the selection of the parameter suitable for each electronic device to be analyzed which is provided in the integrated circuit is automatically carried out using the reference table.

6. The circuit simulation method of claim 5, wherein the reference table is used to associate each electronic device to be analyzed, which is provided in the integrated circuit, with a plurality of weighted parameters.

7. The circuit simulation method of claim 1, wherein the electronic device to be analyzed and the electronic device for measurement are each formed by a MIS transistor or a bipolar transistor.

8. The circuit simulation method of claim 7, wherein the electronic device to be analyzed and the electronic device for measurement are each formed by a MIS transistor comprising a gate electrode, a gate insulating film, an active region and an isolation insulating film surrounding the active region, and
wherein the items, each serving as an index of a stress applied to the electronic device to be analyzed, include at least one of the position of the gate electrode in the active region, the size of the active region, and the width of the isolation insulating film.

9. The circuit simulation method of claim 8, wherein the items, each serving as an index of a stress applied to the electronic device to be analyzed, further include at least one of the depth of the active region, a method for forming the isolation insulating film, the depth of the isolation insulating film, a material for use in forming the isolation insulating film, the size of the gate insulating film, and a material for use in forming the gate insulating film.

10. The circuit simulation method of claim 8, wherein in the step (d), the circuit simulation is performed in consideration of a stress applied from the gate insulating film to the electronic device to be analyzed.

11. The circuit simulation method of claim 1, wherein in the step (b), at least an item that serves as an index of a stress applied from an interlayer dielectric film to the electronic device to be analyzed is measured, and
wherein in the step (d), the circuit simulation is performed in consideration of the stress applied from the interlayer dielectric film to the electronic device to be analyzed.
